(19) United States
(12) Patent Application Publication
(10) Pub. No.: US 2005/0021330 A1
(43) Pub. Date: Jan. 27, 2005

(54) Speech recognition apparatus capable of improving recognition rate regardless of average duration of phonemes

(75) Inventor: Ryuji Mano, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/776,240

(22) Filed: Feb. 12, 2004

(30) Foreign Application Priority Data
Jul. 22, 2003 (JP) 2003-277661(P)

(51) Int. Cl. G10L 15/00

(52) U.S. Cl. 704/231

(57) ABSTRACT

In a speech recognition apparatus, a feature extracting portion extracts feature parameters by sliding a plurality of frames corresponding to time windows each having a prescribed length of time with a successively increasing time width, over an input speech signal. A word lexicon database stores standard pattern data in correspondence with phoneme patterns of the input speech. A recognition processing portion collates the feature parameter extracted by the feature extracting portion with the standard pattern data to recognize a corresponding phoneme, and outputs a recognition result.

### BACKGROUND OF THE INVENTION

1. Field of the Invention

The present invention relates to a configuration of a speech recognition apparatus based on phoneme-by-phoneme recognition.

2. Description of the Background Art

Conventionally, speech recognition in speech recognition apparatuses is in most cases realized by transforming speech to a time sequence of features and by comparing the time sequence with a time sequence of a standard pattern prepared in advance.

By way of example, Japanese Patent Laying-Open No. 2001-356790 discloses a technique in which a feature values extracting part extracts voice feature values from a plurality of time windows of a constant length set at every prescribed period, from the voice as an object of analysis, in a voice recognition device that enables machine-recognition of human speech. According to this technique, a frequency axial series feature parameter concerning the frequency of the voice and a power series feature parameter concerning the amplitude of the voice are extracted in different cycles, respectively.

Japanese Patent Laying-Open No. 5-303391 discloses a technique in which a plurality of units of time (frames) for computing feature parameters are prepared, or prepared phoneme by phoneme, feature parameter time sequences are computed for respective frame lengths and phoneme collating is performed on each of the time sequences, and the optimal one is selected.

In the above described methods in which a plurality of time windows of a constant length are shifted at every prescribed time period while the voice is transformed to time sequences of features, the number of extracted feature parameters may differ dependent on the length of phonemes. As a result, the number of parameters affects the recognition rate.

### SUMMARY OF THE INVENTION

An object of the present invention is to provide a speech recognition apparatus employing a method of computing feature parameters that can improve recognition rate of each phoneme.

The speech recognition apparatus of the present invention includes a feature extracting portion, a storage portion and a recognizing portion. The feature extracting portion extracts a feature parameter by sliding, at least with different time width, a plurality of frames corresponding to time windows each having a prescribed time length, over an input speech signal. The storage portion stores standard pattern data in correspondence with phonetic patterns of the input speech. The recognizing portion collates the feature parameter extracted by the feature extracting portion with the standard pattern data to recognize the corresponding phoneme, and outputs the result of recognition.

According to the speech recognition apparatus of the present invention, it is possible to improve recognition rate of each phoneme, no matter whether average duration of phonemes is long or short, with reduced burden on processing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram representing the configuration of a speech recognition apparatus 10.

FIG. 2 is a schematic illustration representing frame shift by a feature detecting portion 102 shown in FIG. 1.

FIG. 3 is a functional block diagram representing the configuration of a speech recognition apparatus 100.

FIG. 4 is a schematic illustration representing a frame shift operation by a feature parameter computing portion 3021 of speech recognition apparatus 100.

FIG. 5. is a functional block diagram representing a configuration of a speech recognition apparatus 200 in accordance with a second embodiment.

FIG. 6 is a functional block diagram representing a configuration of a speech recognition apparatus 300 in accordance with a fourth embodiment.

FIG. 7 is a functional block diagram representing a configuration of a speech recognition apparatus 400 in accordance with a sixth embodiment.

FIG. 8 is a schematic illustration representing how the standard pattern is stored in a first word lexicon database 6022.

FIG. 9 is a schematic illustration representing a process performed by a data interpolating portion 6032;

FIG. 10 is a functional block diagram representing a configuration of a speech recognition apparatus 500 in accordance with an eighth embodiment.

### DESCRIPTION OF THE PREFERRED EMBODIMENTS

Embodiments of the present invention will be described with reference to the figures.

(Basic Background for Better Understanding of the Present Invention)

As a basic background for help better understanding the configuration of the speech recognition apparatus in accordance with the present invention, configuration and operation of a common speech recognition apparatus 10 will be described.

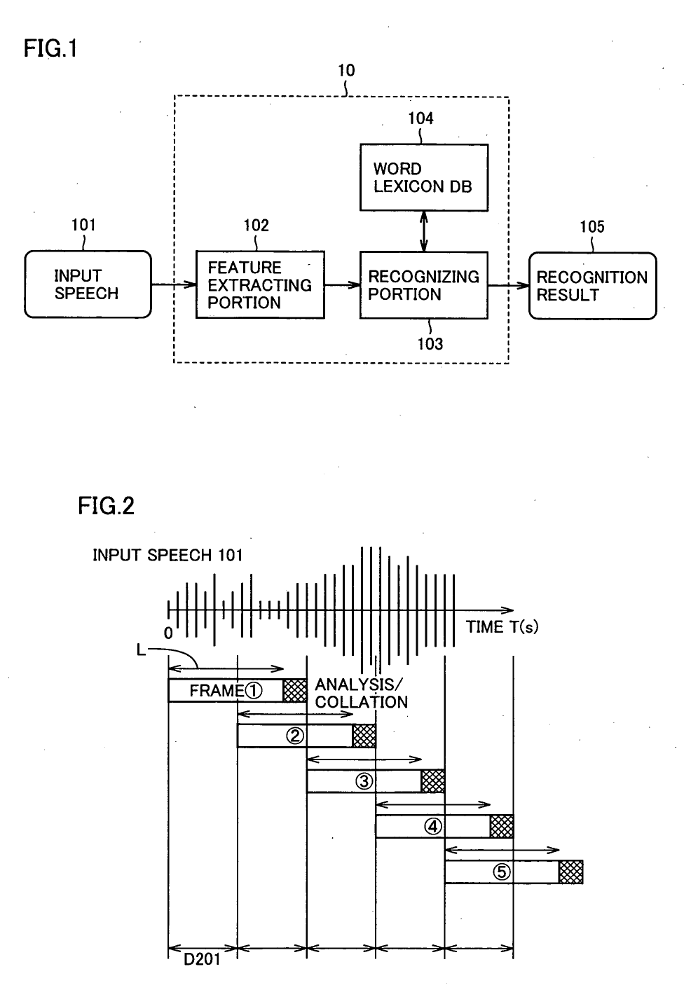

FIG. 1 is a functional block diagram representing the configuration of such a speech recognition apparatus 10.

Referring to FIG. 1, a feature detecting portion 102 computes feature parameters such as an LPC cepstrum coefficient (Fourier transform of logarithmic power spectrum envelope for each frame as a unit of speech segmentation of several tens of milliseconds) for input speech applied as an input. Specifically, when feature detecting portion computes a feature, it typically uses several milliseconds or several tens of milliseconds as a unit time (frame), and computes the feature approximating that the feature, that is the structure of acoustic wave, is in a steady state within the time period of one frame. Thereafter, the feature parameter is again computed with the frame shifted by a certain time period (which operation is referred to as a “frame shift”). By repeating these operations, a time sequence of feature parameter is obtained.

A recognizing portion 103 compares the time sequence of feature parameter obtained in this manner with a standard pattern in a word lexicon database (word lexicon DB) 104 stored in a storage apparatus, computes similarity, and outputs a recognition result 105.

FIG. 2 is a schematic illustration representing the frame shift by a feature detecting portion 102 shown in FIG. 1.

As can be seen from FIG. 2, in feature detecting portion 102 of speech recognition apparatus 10, time width D201 of frame shift is constant. Therefore, words having long phonetic duration and words having short phonetic duration come to have different number of feature parameters. Accordingly, there arises a tendency that a word with a long phoneme has higher recognition rate while a word with a short phoneme has recognition rate lower than that of the word with a long phoneme.

In the present invention, the feature parameters are computed while the time width of frame shift is made variable, so that the same number of feature parameters are generated both for words with long phoneme and words with short phoneme, focusing on portions that are considered critically important in phoneme analysis, as will be described in the following.

[First Embodiment]

The configuration and operation of a speech recognition apparatus 100 in accordance with the first embodiment of the present invention will be described in the following.

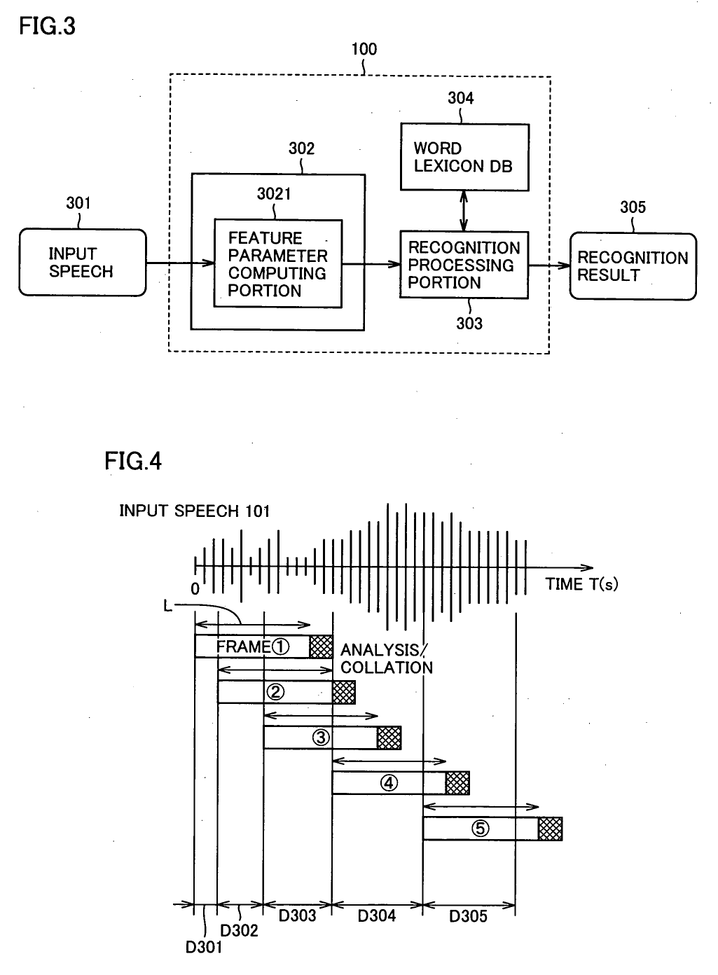

FIG. 3 is a functional block diagram representing the configuration of a speech recognition apparatus 100.

The configuration of speech recognition apparatus 100 is basically the same as speech recognition apparatus 10 shown in FIG. 1.

It is noted, however, that at a feature extracting portion 302 receiving an input speech 301 that is a digitized speech of a speaker, a feature parameter computing portion 3021 makes frame shift interval denser for frame intervals at beginning portions of phonemes and makes the frame intervals gradually coarser toward terminating portions of words while computing the feature parameters. Further, a word lexicon database 304, which is referred to by recognition processing portion 303 for performing the recognizing process after receiving a time sequence of feature parameters computed in this manner, is adapted to store in advance standard patterns corresponding to the frame intervals varying in accordance with a prescribed rule to meet the variable frame intervals, as will be described later. Recognition processing portion 303 refers to word lexicon database as such, performs recognition by collating with the time sequence of feature parameters, and outputs the recognition result.

The operation of speech recognition apparatus 100 will be described in detail in the following.

For phoneme recognition, average duration of each phoneme is important. Features of the phoneme can roughly be classified into beginning, middle and ending portions of words. Consonants represented by pronunciation symbols such as /t/ and /r/ have as short an average duration as about 15 milliseconds at the beginning, middle and ending portions of a word, while vowels have an average duration as long as 100 milliseconds or longer. When various phonemes with such significantly different durations are to be recognized, the data at the initial part of a word is of critical importance. Therefore, in the present invention, time width of the frame shift is changed in accordance with a prescribed rule that will be described below.

FIG. 4 is a schematic illustration representing a frame shift operation by a feature parameter computing portion 3021 of speech recognition apparatus 100.

By way of example, in FIG. 4, it is assumed that from an input speech 301 that has been quantized with 16 bits at a sampling frequency of 20 KHz, feature parameters are computed at a feature parameter computing portion 3021.

Feature parameter computing portion 3021 shifts a fixed frame length L that is a time window, with time widths D301 to D30n (e.g.: D301<D302<D303< . . . <D30n, n: natural number) that become gradually longer from the starting portion to the end of the input speech, and generates feature parameter time sequences S1 to Sn.

When time widths D301 to D30n are made gradually longer, the time interval D301 from the head frame to the next frame may be used as a reference, and the following time intervals D302 to D30n may be gradually made longer in geometric series at a prescribed rate, or the following time intervals D302 to D30n may be gradually made longer in arithmetic series with a prescribed interval, though not limiting. Alternatively, the following time intervals D302 to D30n may be gradually made longer in more general manner, in accordance with a function that monotonously increases with time.

First, data of the frame length L from the beginning of the input speech 301 is considered, and a feature parameter is computed assuming that the data in this range are in a steady state. For instance, from a 12th order linear predictive coding (LPC), a 16th order LPC cepstrum coefficient is computed and made to a 16-dimensional feature vector. Thereafter, the frame is shifted with the time width of D30i (i=1 to n), and the feature vector is computed in the similar manner. This operation is repeated to the end of input speech 301, and a time sequence Sn of feature parameters computed with the fixed frame length L is obtained.

When the feature parameters are output from feature parameter computing portion 3021, parameters are compared with word lexicon database 304 frame by frame. After all the frames are compared, a most suitable model that satisfies a threshold value among the models registered in word lexicon database 304 is output as the recognition result 305.

Here, as the data to be stored in word lexicon database 304, standard patterns are prepared beforehand, using feature parameters computed with frame shift of time widths D301 to D30n with the frame length of L, for individual phoneme models. Such standard patterns are formed by preparing and training individual Hidden Markov Model (HMM) P01, with the feature parameter time sequences computed using a speech database of which contents of speech and phonetic periods are known in advance. Word lexicon database 304 is configured by the HMM model of the phoneme number M (M: prescribed natural number) obtained in this manner.

Recognizing processing portion 303 checks position of presence and probability of presence of all the phonemes, and of those overlapping in position of presence, one having higher probability of presence is left. A sequence of phonemes obtained in this manner is output as recognition result 305.

By speech recognition apparatus having the above-described configuration, it becomes possible to improve recognition rate by increasing weight of a feature parameter corresponding to the beginning portion of a phoneme, as compared with the phoneme recognition rate with the time width of frame shift being fixed.

[Second Embodiment]

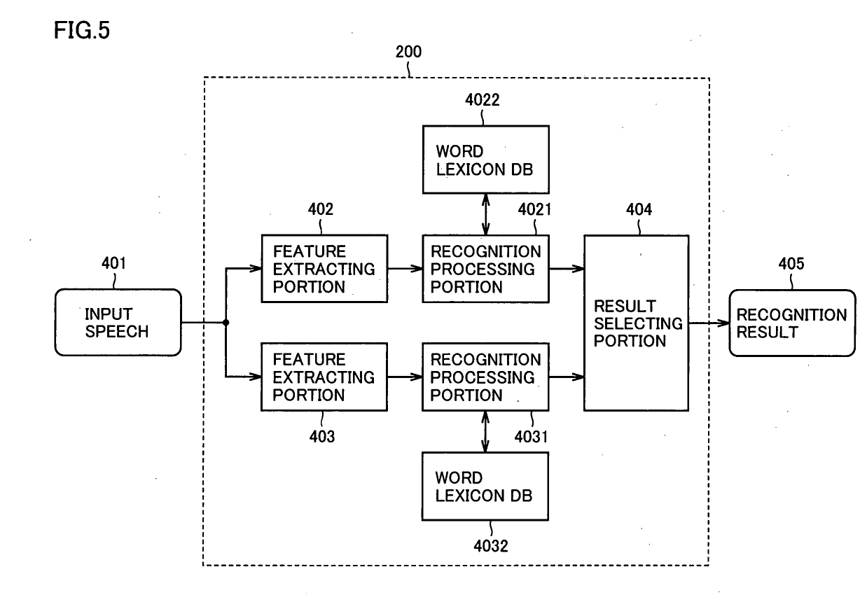

FIG. 5 is a functional block diagram representing a configuration of a speech recognition apparatus 200 in accordance with a second embodiment.

In the following, the process procedure of extracting feature parameters while the interval between frames as the time window is fixed will be referred to as “fixed-frame-interval extraction process.”

Speech recognition apparatus 200 shown in FIG. 5 includes a first feature extracting portion 402 having a first feature parameter computing portion performing the fixed-frame-interval extraction process at a first time interval on a digitized input speech 401, and a second feature extracting portion 403 having a second feature parameter computing portion performing the fixed-frame-interval extraction process at a second time interval.

By the first and second feature extracting portions 402 and 403, first feature parameter time sequences S01 to S0n and second feature parameter time sequences S11 to S1n are computed.

Speech recognition apparatus 200 further includes a first word lexicon database 4022 having phoneme models corresponding to the fixed-frame-interval extraction process with the first time interval registered in advance, a second word lexicon database 4032 having phoneme models corresponding to the fixed-frame-interval extraction process with the second time interval registered in advance, a first recognition processing portion 4021 comparing each of the feature parameters computed by the first feature extracting portion 402 with data in the first word lexicon database 4022, a second recognition processing portion 4031 comparing each of the feature parameters computed by the second feature extracting portion 403 with data in the second word lexicon database 4032, and a result selecting portion 404 selecting recognition result of first or second recognition processing portion 4021 or 4031 in accordance with relevance thereof and obtaining a recognition result 405.

The operation of speech recognition apparatus 200 will be described in grater detail in the following.

First, data of the frame length L from the beginning of the input speech 401 is considered, and a feature parameter is computed by first and second feature extracting portions 402 and 403, assuming that the data in this range are in a steady state.

In speech recognition apparatus 200, from a 12th order linear predictive coding LPC, a 16th order LPC cepstrum coefficient is computed and made to a 16-dimensional feature vector by the first feature extracting portion 402. Similarly, from a 12th order linear predictive coding LPC, a 16th order LPC cepstrum coefficient is computed and made to a 16-dimensional feature vector by the second feature extracting portion 403.

As a result, first and second feature parameters S01 and S11 are obtained at the first and second feature parameter extracting portions 402 and 403, respectively. After this operation, until the end of input speech 401, the first feature extracting portion 402 outputs first feature parameters SOn computed with frame shift repeated at a fixed time width D201, and the second feature extracting portion 403 outputs second feature parameters Sln computed with fame shift repeated at a fixed time width D2011 (<D201).

On the other hand, first standard patterns are formed beforehand for each phoneme model, using feature parameters computed from the frame length L. The first standard patterns are formed by preparing and training individual Hidden Markov Model (HMM) P01, with the feature parameter time sequences computed using a speech database of which contents of speech and phonetic periods are known in advance (here, the feature parameter time sequences are formed with the time width of frame shift set to D201). First word lexicon database 4022 is configured by the HMM model of the phoneme number M obtained in this manner.

Further, second standard patterns are similarly formed beforehand, using feature parameters computed from the frame length L. The second standard patterns are formed by preparing and training individual Hidden Markov Model (HMM) P11, with the feature parameter time sequences computed using a speech database of which contents of speech and phonetic periods are known in advance (here, the feature parameter time sequences are formed with the time width of frame shift set to D2011). Second word lexicon database 4032 is configured by the HMM model of the phoneme number M obtained in this manner.

At the first recognition processing portion 4021, collation is performed for feature parameter time sequence S01 using standard patterns P01 and for feature parameter time sequence S02 using standard patterns P02, starting from the initial frame of the input speech, phoneme by phoneme. In the similar manner, phoneme collation is performed for the feature parameter time sequence S0n using standard patterns P0n, and those of which position of presence and probability of presence overlap are output.

Similarly, at the second recognition processing portion 4031, collation is performed for feature parameter time sequence S11 using standard patterns P11 and for feature parameter time sequence S12 using standard patterns P12, starting from the initial frame of the input speech, phoneme by phoneme. In the similar manner, phoneme collation is performed for the feature parameter time sequence S1n using standard patterns P1n, and those of which position of presence and probability of presence overlap are output.

Result selecting portion 404 checks position of presence and probability of presence for all the phonemes output from the first and second recognition processing portions 4021 and 4031, and of those overlapping in position of presence, one having higher probability of presence is left. Result selecting portion 404 outputs a sequence of phonemes obtained in this manner as recognition result 405.

By speech recognition apparatus 200 having the above-described configuration, it becomes possible to improve recognition rate by using feature parameters extracted with different time intervals between frames and selecting results with higher probability of presence, as compared with the phoneme recognition rate with the time width of frame shift being fixed.

[Third Embodiment]

In the following, a process procedure of extracting feature parameters while the interval between frames as the time window is made successively longer will be referred to as “variable-frame-interval extraction process.”

In the second embodiment, it has been assumed that both the first and second feature extracting portions 402 and 403 perform the fixed-frame-interval extraction process.

Basic configuration of the speech recognition apparatus in accordance with the third embodiment of the present invention is the same as that of speech recognition apparatus 200 in accordance with the second embodiment.

It is noted, however, that the second feature extracting portion 403 performs the variable-frame-interval extraction process.

Specifically, the second feature extracting portion 403 varies the time interval of frame shift D30i (i: natural number, D301<D302<D303< . . . ) to be gradually longer, while computing respective feature parameters.

For the second word lexicon database 4032, standard patterns are prepared beforehand, using feature parameters computed with the time width of frame shift set at D30i (i: natural number, D301<D302<D303< . . . ).

Other configurations of the speech recognition apparatus in accordance with the third embodiment are the same as those of speech recognition apparatus 200 in accordance with the second embodiment, and therefore, description thereof will not be repeated.

By the speech recognition apparatus in accordance with the third embodiment having such a configuration, it becomes possible to effectively handle phonemes having long average duration by the fixed-frame-interval extracting process and to effectively handle phonemes having short average duration by the variable-frame-interval extracting process, and therefore, in addition to the effects attained by speech recognition apparatus 200, a further effect of alleviating burden of processing can be attained.

[Fourth Embodiment]

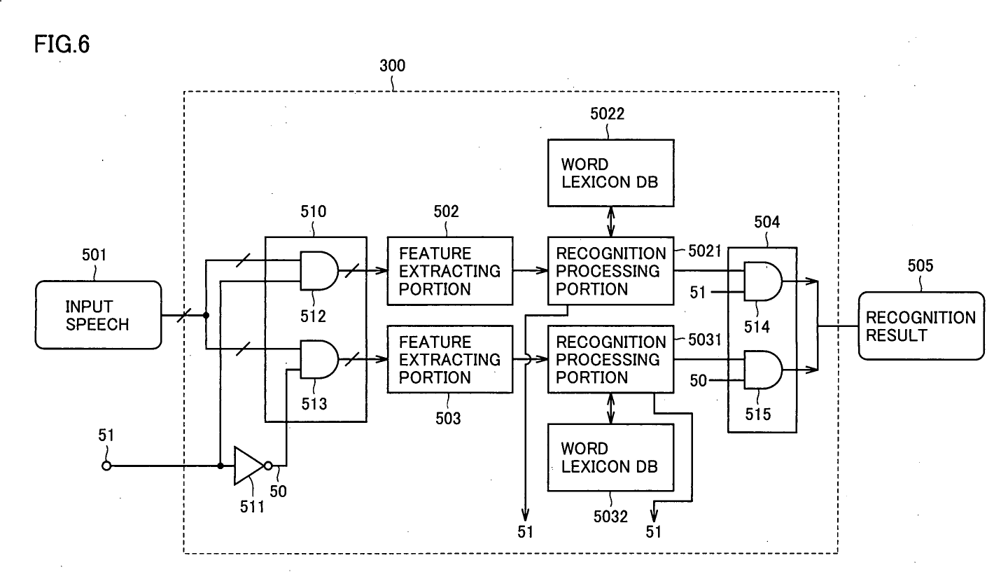

FIG. 6 is a functional block diagram representing a configuration of a speech recognition apparatus 300 in accordance with a fourth embodiment.

Speech recognition apparatus 300 shown in FIG. 6 includes a first feature extracting portion 502 having a first feature parameter computing portion performing the fixed-frame-interval extraction process at a first time interval, and a second feature extracting portion 503 having a second feature parameter computing portion performing the fixed-frame-interval extraction process at a second time interval, on a digitized input speech 501.

Speech recognition apparatus 300 further includes an inverter 511 receiving as an input a control signal 51 that will be described later, and an input selecting portion 510 responsive to control signal 51 and an output signal 50 of inverter 511 to selectively apply the input speech 501 either to the first feature extracting portion 502 or the second feature extracting portion 503.

Input selecting portion 510 includes an AND circuit 512 receiving input speech 501 and control signal 51 at inputs and providing an output to the first feature extracting portion 502, and an AND circuit 513 receiving input speech 501 and output 50 of inverter 511 and providing an output to the second feature extracting portion 503.

The first and second feature extracting portions 502 and 503 compute the first and second feature parameter time sequences S01 to S0n and S11 to S1n, respectively.

Speech recognition apparatus 300 further includes a first word lexicon database 5022 having phoneme models corresponding to the fixed-frame-interval extracting process at the first time interval registered in advance, a second word lexicon database 5032 having phoneme models corresponding to the fixed-frame-interval extracting process at the second time interval registered in advance, a first recognition processing portion 5021 comparing each of the feature parameters computed by the first feature extracting portion 502 with the data in the first word lexicon database 5022 for phoneme recognition, a second recognition processing portion 5031 comparing each of the feature parameters computed by the second feature extracting portion 503 with the data in the second word lexicon database 5032 for phoneme recognition, and a result selecting portion 504 selecting recognition results of the first and second recognition processing portions 5021 and 5031 in accordance with the procedure described in the following to obtain a recognition result 505.

Result selecting portion 504 includes an AND circuit 514 receiving an output of the first recognition processing portion 5021 and control signal 51 at inputs and outputting recognition result 505, and an AND circuit 515 receiving an output of the second recognition processing portion 5031 and output signal 50 and outputting recognition result 505.

The operation of speech recognition apparatus 300 will be described in the following.

First, data of the frame length L from the beginning of the input speech 501 is considered, and a feature parameter is computed by first or second feature extracting portion 502 or 503 in response to control signal 51, assuming that the data in this range are in a steady state.

Here, it is assumed that control signal 51 changes such that in the recognition process at the first recognition processing portion 5021, when a threshold value set for obtaining a recognition result is satisfied, the speech is input to the first feature extracting portion 502, and when the threshold value is not satisfied by the first recognition processing portion 5021, the speech is input to the second feature extracting portion 503.

By way of example, consider an input speech 501 of which beginning part of the word is the same as some of the registered words, while ending part is different. In such a case, in the first processing system consisting of the first feature extracting portion 502 and the first recognition processing portion 5021, it becomes less and less likely that the threshold value is satisfied, when the recognition process is performed frame by frame from the beginning part to the ending part of the word.

At this time, the first recognition processing portion 5021 returns a control flag as control signal 51, and by that flag, the recognition process is switched to the second processing system consisting of the second feature extracting portion 503 and the second recognition processing portion 5031, whereby the recognition process is performed with the shift time width varied.

In the following, description will be given assuming that in the fourth embodiment, the time width of frame shift in the second processing system mentioned above is shorter than the time width of frame shift in the first processing system.

In the fourth embodiment, from a 12th order linear predictive coding LPC, a 16th order LPC cepstrum coefficient is computed and made to a 16-dimensional feature vector, by the first and second feature extracting portions 502 and 503.

As a result, the first feature parameter S01 and the second feature parameter S11 are obtained at the first and second feature extracting portions 502 and 503, respectively. After this operation, until the end of the input signal, the first feature extracting portion 502 outputs first feature parameters S0n computed with frame shift repeated at a fixed time width D201, and the second feature extracting portion 503 outputs second feature parameters S in computed with fame shift repeated at a fixed time width D2011 (<D201).

As in the second embodiment, it is assumed that the first and second word lexicon databases 5022 and 5033 store the first and second standard patterns consisting of HMM models for respective phoneme models, which correspond to the feature parameter time sequences formed with the time width of frame shift set to D201 and the feature parameter time sequences formed with the time width of frame shift set to D2011, respectively.

The first recognition processing portion 5021 uses standard pattern P01 for the feature parameter time sequence S01 and standard pattern P02 for the second feature parameter time sequence S02, frame by frame, starting from the initial frame of the input speech. Similarly, the first recognition processing portion 5021 uses standard pattern POx (x: natural number) for the feature parameter time sequence S0x, and outputs those satisfying the overlapping of position of presence and probability of presence, and the set threshold value. When the set threshold value is not satisfied while this process is repeated, the first recognition processing portion 5021 generates a switching signal to invert control signal 51, whereby the process is switched such that phoneme collation is performed by the second recognition processing portion 5031 using outputs of the second feature extracting portion 503. Specifically, after switching, the second recognition processing portion 5031 uses standard pattern P1(x+1) for the feature parameter time sequence S1(x+1) and standard pattern P1(x+2) for the second feature parameter time sequence S1(x+2), frame by frame, thereafter, uses standard pattern P1n for the feature parameter time sequence S1n in the similar manner, to perform phoneme collation, and outputs those that overlap in the position of presence and probability of presence.

Then, result selecting portion 504 outputs a phoneme sequence resulting from the processing by the first or second processing systems as the final recognition result 505.

By speech recognition apparatus 300 having the above-described configuration in accordance with the fourth embodiment, it becomes possible to improve recognition rate, as compared with the phoneme recognition rate with the time width of frame shift being fixed.

As another effect, it is possible that another processing system, not shown, is provided, which system is not specifically limited, a signal may be generated indicating that said another processing system is in operation, and the signal may be used as the control signal 51. By such an approach, it becomes possible in the system including the speech signal processing apparatus 300 to alleviate the processing burden of a CPU (Central Processing Unit).

[Fifth Embodiment]

In the fourth embodiment, it is assumed that both the first and second feature extracting portions 502 and 503 perform the fixed-frame-interval feature extracting process.

Basic configuration of the speech recognition apparatus in accordance with the fifth embodiment of the present invention is the same as that of speech recognition apparatus 300 in accordance with the fourth embodiment.

It is noted, however, that the second feature extracting portion 503 performs the variable-frame-interval extraction process, in the speech recognition apparatus in accordance with the fifth embodiment.

Specifically, the second feature extracting portion 503 varies the time width of frame shift D30i (i: natural number, D301<D302<D303< . . . ) to be gradually longer, while computing respective feature parameters, as described with reference to FIG. 4.

For the second word lexicon database 5032, standard patterns are prepared beforehand, using feature parameters computed with the time width of frame shift set at D30i (i: natural number, D301<D302<D303< . . . ).

Other configurations of the speech recognition apparatus in accordance with the fifth embodiment are the same as those of speech recognition apparatus 300 in accordance with the fourth embodiment, and therefore, description thereof will not be repeated.

By the speech recognition apparatus in accordance with the fifth embodiment having such a configuration, it becomes possible to effectively handle phonemes having long average duration by the fixed-frame-interval extracting process and to effectively handle phonemes having short average duration by the variable-frame-interval extracting process, and therefore, in addition to the effects attained by speech recognition apparatus 300, a further effect of alleviating burden of processing can be attained.

[Sixth Embodiment]

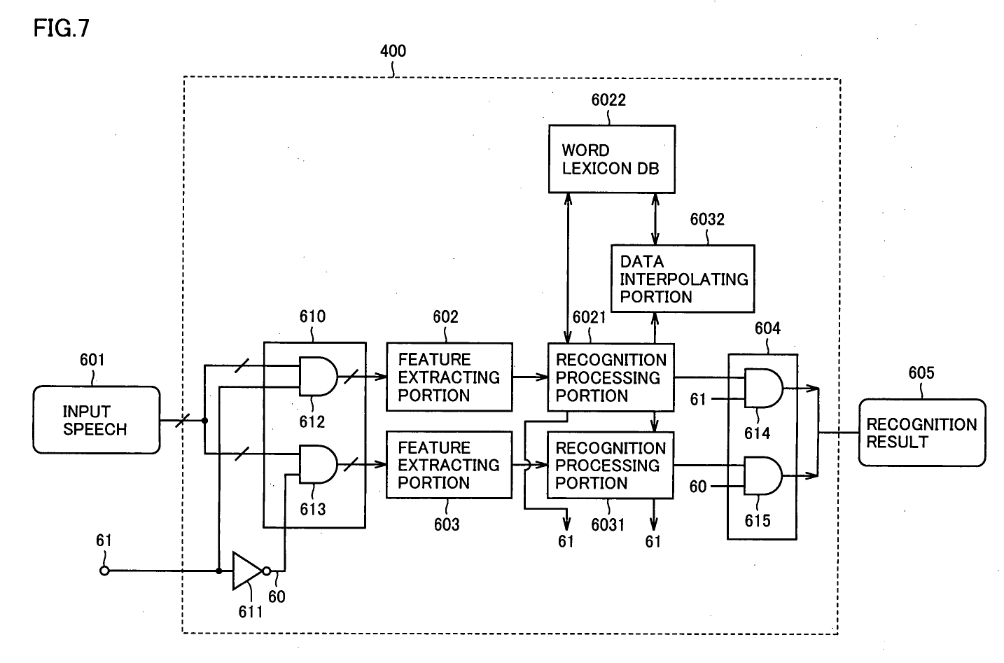

FIG. 7 is a functional block diagram representing a configuration of a speech recognition apparatus 400 in accordance with a sixth embodiment.

In speech recognition apparatus 400 shown in FIG. 7, an input speech 601, an input selecting portion 610, a control signal 61, an inverter 611, a first feature extracting portion 602, a second feature extracting portion 603, a first recognition processing portion 6021, a second recognition processing portion 603.1, a result selecting portion 604, a first word lexicon database 6022 and recognition result 605 respectively have functions corresponding to input speech 501, input selecting portion 510, control signal 51, inverter 511, first feature extracting portion 502, second feature extracting portion 503, first recognition processing portion 5021, second recognition processing portion 5031, result selecting portion 504, first word lexicon database 5022 and recognition result 505, of speech recognition apparatus 300 in accordance with the fourth embodiment.

In speech recognition apparatus 400 shown in FIG. 7, different from the configuration of speech recognition apparatus 300 in accordance with the fourth embodiment, a data interpolating portion 6032 is provided in place of the second word lexicon database 5032.

It is also assumed in speech recognition apparatus 400 shown in FIG. 7, that the time width D2011 of frame shift in the second processing system consisting of the second feature extracting portion 503 and the second recognition processing portion 5031 is shorter than the time width D201 of frame shift in the first processing system consisting of the first feature extracting portion 502 and the first recognition processing portion 5021.

Here, also in speech recognition apparatus 400, first standard patterns are formed beforehand for each phoneme model, using feature parameters computed from the frame length L. The first standard patterns are formed by preparing and training individual Hidden Markov Model (HMM) P01, with the feature parameter time sequences computed using a speech database of which contents of speech and phonetic periods are known in advance (here, the feature parameter time sequences are formed with the time width of frame shift set to D201). Thus, first word lexicon database 6022 is configured by the HMM model of the phoneme number M obtained in this manner.

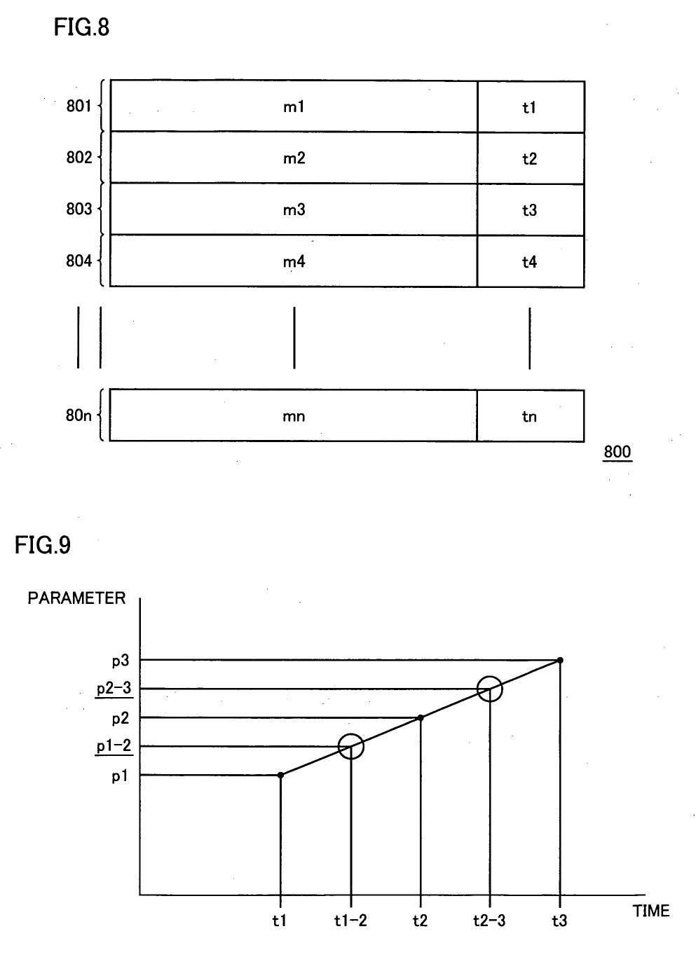

FIG. 8 is a schematic illustration representing how the standard pattern is stored in a first word lexicon database 6022.

As shown in FIG. 8, for the HMM model corresponding to phonemes, the first standard patterns 801 to 80n in a prescribed time period are provided as parameters m1 to mn at time points t1 to tn, respectively.

In speech recognition apparatus 400, time width D2011 of frame shift in the second processing system is shorter that time width D201 of frame shift D201 for the first processing system, and therefore, even when the first standard patterns are to be used as the second standard patterns for the second recognition processing portion 5031, some portions are missing for the second standard patterns, in the first word lexicon database 6022.

Therefore, in speech recognition apparatus 400, the second standard patterns are generated by interpolating portion 6032, based on the first standard patterns.

FIG. 9 is a schematic illustration representing a process performed by a data interpolating portion 6032.

As shown in FIG. 9, the second standard pattern at every time point can be formed by computing the intermediate data by linear interpolation (or by any function of high order), using the first standard patterns and time data.

Other configurations of the speech recognition apparatus 400 are the same as those of the fourth embodiment, and therefore, description thereof will not be repeated.

By the configuration of speech recognition apparatus 400 as described above, it becomes possible to reduce storage capacity of a storage apparatus such as a memory used as the word lexicon database.

[Seventh Embodiment]

In the sixth embodiment, it is assumed that both the first and second feature extracting portions 602 and 603 perform the fixed-frame-interval feature extracting process.

Basic configuration of the speech recognition apparatus in accordance with the seventh embodiment of the present invention is the same as that of speech recognition apparatus 400 in accordance with the sixth embodiment.

It is noted, however, that the second feature extracting portion 603 performs the variable-frame-interval extraction process, in the speech recognition apparatus in accordance with the seventh embodiment.

Specifically, the second feature extracting portion 603 varies the time width of frame shift D30i (i: natural number, D301<D302<D303< . . . ) to be gradually longer, while computing respective feature parameters, as described with reference to FIG. 4.

In generating the second standard patterns, all the standard patterns are formed by data interpolating portion 6032 using the first word lexicon database 6022, as in the sixth embodiment.

Other configurations of the speech recognition apparatus in accordance with the seventh embodiment are the same as those of speech recognition apparatus 400 in accordance with the sixth embodiment, and therefore, description thereof will not be repeated.

By the speech recognition apparatus in accordance with the seventh embodiment having such a configuration, it becomes possible to effectively handle phonemes having long average duration by the fixed-frame-interval extracting process and to effectively handle phonemes having short average duration by the variable-frame-interval extracting process, and therefore, in addition to the effects attained by speech recognition apparatus 300, a further effect of alleviating burden of processing can be attained.

[Eighth Embodiment]

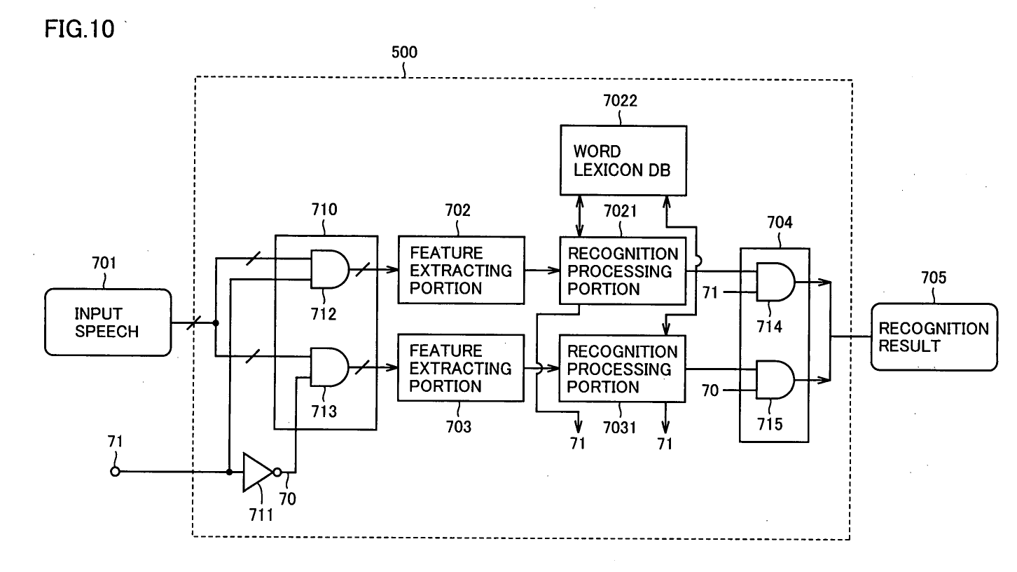

FIG. 10 is a functional block diagram representing a configuration of a speech recognition apparatus 500 in accordance with an eighth embodiment.

In the configuration of speech recognition apparatus 500 shown in FIG. 10, an input speech 701, an input selecting portion 710, a control signal 71, an inverter 711, a first feature extracting portion 702, a second feature extracting portion 703, a first recognition processing portion 7021, a second recognition processing portion 7031, a result selecting portion 704, a first word lexicon database 7022 and recognition result 705 respectively have functions corresponding to input speech 601, input selecting portion 610, control signal 61, inverter 611, first feature extracting portion 602, second feature extracting portion 603, first recognition processing portion 6021, second recognition processing portion 6031, result selecting portion 604, first word lexicon database 6022 and recognition result 605 of speech recognition apparatus 400 in accordance with the sixth embodiment.

Here, also in speech recognition apparatus 500, first standard patterns are formed beforehand for each phoneme model, using feature parameters computed from the frame length L. The first standard patterns are formed by preparing and training individual Hidden Markov Model (HMM) P01, with the feature parameter time sequences computed using a speech database of which-contents of speech and phonetic periods are known in advance (here, the feature parameter time sequences are formed with the time width of frame shift set to D201). Thus, first word lexicon database 7022 is configured by the HMM model of the phoneme number M obtained in this manner.

It is assumed that also in the first word lexicon database 7022, time and parameters are stored in correspondence with each other as shown in FIG. 8.

In speech recognition apparatus 500, time width D2011 of frame shift for the second processing system is longer than time width D201 of frame shift for the first processing system and, in addition, relation between the time width D2011 and time width D201 is determined such that each time point during variation with the longer time width D2011 corresponds to or linked with a time point during variation with the shorter time width D201.

By way of example, variation with time width D201 may be in geometric series or in arithmetic series with respect to the variation with time width D2011, and in that case, the second standard patterns can be formed from the first standard patterns without necessitating any special interpolating operation as required in the sixth embodiment.

Other configurations and operations of the speech recognition apparatus in accordance with the eighth embodiment, and therefore, description thereof will not be repeated.

By the speech recognition apparatus in accordance with the eighth embodiment having such a configuration, in addition to the effects attained by speech recognition apparatus 400, a further effect of alleviating burden of processing can be attained.

Although the present invention has been described and illustrated in detail, it is clearly understood that the same is by way of illustration and example only and is not to be taken by way of limitation, the spirit and scope of the present invention being limited only by the terms of the appended claims.

1. A speech recognition apparatus, comprising:
a feature extracting portion extracting a feature parameter by sliding, at least with different time width, a plurality of frames corresponding to time windows each having a prescribed length of time, over an input speech signal;
a storing portion storing standard pattern data in correspondence with phoneme patterns, respectively, of said input speech; and
a recognizing portion collating said feature parameter extracted by said feature extracting pattern with said standard pattern data to recognize a corresponding phoneme and to output a recognition result.

2. The speech recognition apparatus according to claim 1, wherein
said feature extracting portion successively increases time width for sliding said frame from a beginning part to an ending part of said input speech signal; and
said storing portion stores said standard pattern data corresponding to a pattern of time width with which said feature extracting portion slides said frame.

3. The speech recognition apparatus according to claim 1, wherein
said feature extracting portion includes
a first fixed-frame-interval extraction processing portion extracting said feature parameter while sliding said frame with a first fixed time width, and
a second fixed-frame-interval extraction processing portion extracting said feature parameter while sliding said frame with a second fixed time width shorter than said first fixed time width; and
said standard pattern data include first standard pattern data corresponding to a first pattern of time width with which said first fixed-frame-interval extraction processing portion slides said frame, and a second standard pattern data corresponding to a second pattern of time width with which said second fixed-frame-interval extraction processing portion slides said frame.

4. The speech recognition apparatus according to claim 1, wherein
said feature extracting portion includes
a fixed-frame-interval extraction processing portion extracting said parameter while sliding said frame with a fixed time width, and
a variable-frame-interval extraction processing portion extracting said parameter while successively increasing time width for sliding said frame, from a beginning part to an ending part of said input speech; and
said standard pattern data include
first standard pattern data corresponding to a first pattern of time width with which said fixed-frame-interval extraction processing portion slides said frame, and a second standard pattern data corresponding to a second pattern of time width with which said variable-frame-interval extraction processing portion slides said frame.

5. The speech recognition apparatus according to claim 1, wherein
said feature extracting portion includes
a first fixed-frame-interval extraction processing portion extracting said feature parameter while sliding said frame with a first fixed time width, and
a second fixed-frame-interval extraction processing portion extracting said feature parameter while sliding said frame with a second fixed time width shorter than said first fixed time width; and
said standard pattern data include first standard pattern data corresponding to a first pattern of time width with which said first fixed-frame-interval extraction processing portion slides said frame, and a second standard pattern data corresponding to a second pattern of time width with which said second fixed-frame-interval extraction processing portion slides said frame;
said speech recognition apparatus further comprising
an input selecting portion provided between said input speech signal and said feature extracting portion, for switching destination of said input speech signal from said first fixed-frame-interval extraction processing portion to said second fixed-frame-interval extraction processing portion in accordance with a result of collation by said recognizing portion based on said feature parameter extracted by said first fixed-frame-interval extraction processing portion.

6. The speech recognition apparatus according to claim 5, wherein
said first standard pattern data are related to time;
said speech recognition apparatus further comprising
an interpolating portion generating said second standard pattern data by interpolation, based on said first standard pattern data.

7. The speech recognition apparatus according to claim 6; wherein
said first standard pattern data and said second standard pattern data are related to time; and
each time point, at which said second fixed-frame-interval extraction processing portion slides said frame, corresponds to any of time points at which said first fixed-frame-interval extraction processing portion slides said frame.

8. The speech recognition apparatus according to claim 1, wherein
said feature extracting portion includes
a fixed-frame-interval extraction processing portion extracting said feature parameter while sliding said frame with a fixed time width, and
a variable-frame-interval extraction processing portion extracting said parameter while successively increasing time width for sliding said frame, from a beginning part to an ending part of said input speech; and
said standard pattern data include
first standard pattern data corresponding to a first pattern of time width with which said fixed-frame-interval extraction processing portion slides said frame, and a second standard pattern data corresponding to a second pattern of time width with which said variable-frame-interval extraction processing portion slides said frame;
said speech recognition apparatus further comprising
an input selecting portion provided between said input speech signal and said feature extracting portion, for switching destination of said input speech signal from said fixed-frame-interval extraction processing portion to said variable-frame-interval extraction processing portion in accordance with a result of collation by said recognizing portion based on said feature parameter extracted by said first fixed-frame-interval extraction processing portion.

9. The speech recognition apparatus according to claim 8, wherein
said first standard pattern data are related to time;
said speech recognition apparatus further comprising
an interpolating portion generating said second standard pattern data by interpolation, based on said first standard pattern data.
